(19) United States
(12) Patent Application Publication
(10) Pub. No.: US 2015/0143526 A1
(43) Pub. Date: May 21, 2015

(54) ACCESS POINT CONTROLLER AND CONTROL METHOD THEREOF

(71) Applicant: DAVOLINK INC., Anyang-si (KR)

(72) Inventors: Youn Geun JEON, Seongnam-si (KR); Seong Ho JEON, Ansan-si (KR); Seung Ro JANG, Euiwang-si (KR); Kyoung Hwan PARK, Gwacheon-si (KR)

(73) Assignee: DAVOLINK INC., Anyang-si (KR)

(21) Appl. No.: 14/273,879

(22) Filed: May 9, 2014

(30) Foreign Application Priority Data
Nov. 19, 2013 (KR) 10-2013-0140460

(51) Int. Cl. H04L 29/06

(52) U.S. Cl. CPC H04L 63/1433
USPC 726/25

(57) ABSTRACT

Provided is a control method of an access point controller (APC), the method including: (a) if occurrence of a predetermined security vulnerability checking event on particular terminal equipment is sensed, controlling the plurality of APs so that port scanning is capable of being performed on the particular terminal equipment; and (b) determining that security vulnerability has occurred in the particular terminal equipment in at least one of a case where the predetermined port is opened, a case where the predetermined port is closed, and a case where the number of opened ports exceeds a predetermined number, as a result of performing port scanning on the particular terminal equipment.

### CROSS-REFERENCE TO RELATED PATENT APPLICATION

This application claims the benefit of Korean Patent Application No.

10-2013-0140460, filed on Nov. 19, 2013, in the Korean Intellectual Property Office, the disclosure of which is incorporated herein in its entirety by reference.

### BACKGROUND OF THE INVENTION

1. Field of the Invention

The present invention relates to an access point controller (APC) and a control method thereof, and more particularly, to an APC in which security vulnerability of terminal equipment that performs communication via an access point (AP) can be found, and a control method of the APC.

2. Description of the Related Art

Various types of wireless communication services are recently provided owing to the development of communication technology. For example, user's each communication terminal equipment may communicate with an external communication network via a local wireless LAN. In this case, wireless communication terminal equipment need to always pass through an access point (AP).

The AP may be provided at home or a public place, such as a library or a coffee shop.

In particular, when a plurality of APs are provided at the same place, such as the public place, an access point controller (APC) for controlling the plurality of APs may be additionally required.

The APC performs a function of performing user authentication and controlling the APs so that communication connection can be performed or not on the communication terminal equipment according to user authentication.

However, among them, in particular, as described above, communication terminal equipment that performs local wireless communication through the APs have so many possibilities that the communication terminal equipment may be attacked from other peripheral terminal equipment in a wireless section, and communication terminal equipment having vulnerability of wireless communication may be hacked due to other terminal equipment's attack.

Of course, there is no problem when a user of communication terminal equipment has sufficient security-related knowledge and properly prevents vulnerability of wireless communication. However, realistically, it is not easy for many users to have security-related knowledge. Thus, provision of services in which vulnerability of wireless communication of communication terminal equipment that accesses the AP can be easily found, is required.

### PRIOR-ART DOCUMENT

(Patent document 1) Korean Patent Laid-open Publication No. 10-2013-0073684

### SUMMARY OF THE INVENTION

The present invention provides an access point controller (APC) in which vulnerability of each communication terminal equipment that accesses an access point (AP) can be found, and a control method of the APC.

According to an aspect of the present invention, there is provided an access point controller (APC) so that predetermined terminal equipment is capable of being connected to a predetermined communication network via a plurality of access points (APs), the APC including: a sensing unit sensing whether a predetermined security vulnerability checking event on particular terminal equipment occurs; a port scanning performing controller controlling port scanning on the particular terminal equipment if occurrence of the predetermined security vulnerability checking event on the particular terminal equipment is sensed by the sensing unit; and a security vulnerability determining unit determining that security vulnerability has occurred in the particular terminal equipment in at least one of a case where the predetermined port is opened, a case where the predetermined port is closed, and a case where the number of opened ports exceeds a predetermined number, as a result of performing port scanning on the particular terminal equipment.

According to another aspect of the present invention, there is provided a control method of an access point controller (APC) so that predetermined terminal equipment is capable of being connected to a predetermined communication network via a plurality of access points (APs), the control method including: (a) if occurrence of a predetermined security vulnerability checking event on particular terminal equipment is sensed, controlling port scanning on the particular terminal equipment; and (b) determining that security vulnerability has occurred in the particular terminal equipment in at least one of a case where the predetermined port is opened, a case where the predetermined port is closed, and a case where the number of opened ports exceeds a predetermined number, as a result of performing port scanning on the particular terminal equipment.

### BRIEF DESCRIPTION OF THE DRAWINGS

The above and other features and advantages of the present invention will become more apparent by describing in detail exemplary embodiments thereof with reference to the attached drawings in which:

FIG. 1 schematically illustrates a configuration of a whole communication system including an access point controller (APC) according to an embodiment of the present invention;

FIG. 2 is a functional block diagram of the APC illustrated in FIG. 1; and

FIGS. 3 through 6 are control and signal flowcharts of the whole communication system including the APC illustrated in FIG. 1.

### DETAILED DESCRIPTION OF THE INVENTION

The present invention will now be described more fully with reference to the accompanying drawings, in which exemplary embodiments of the invention are shown.

Hereinafter, each of embodiments of the present invention is just an example for assisting with understanding of the present invention, and the present invention is not limited to the embodiment. In particular, the present invention may be configured of a combination of at least one from among an individual configuration, an individual function, and an individual step included in each embodiment.

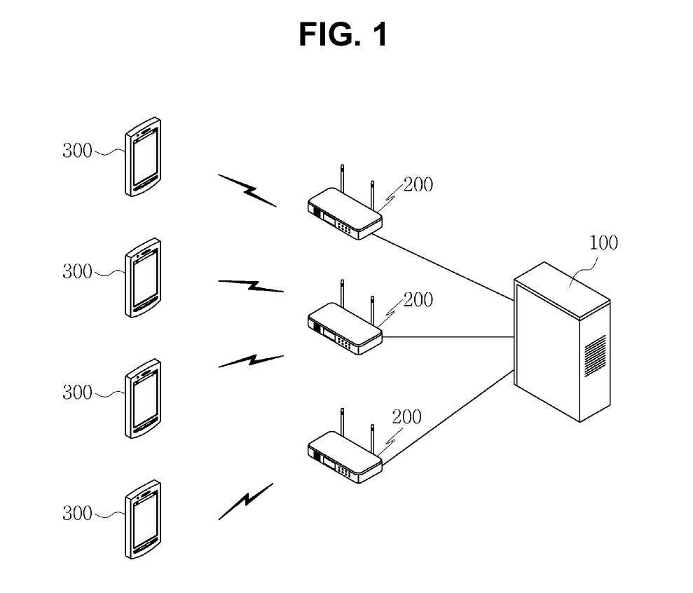

A schematic configuration of a whole communication system including an access point controller (APC) 100 according to an embodiment of the present invention is as illustrated in FIG. 1.

As illustrated in the same drawing, the whole communication system may include at least one communication terminal equipment 300, at least one access point (AP) 200, and the APC 100.

Of course, as the size of a communication system is increased, a plurality of APCs 100 may be configured.

The communication terminal equipment 300 is terminal equipment having a local wireless LAN communication function and may correspond to a portable terminal device having a local wireless communication module, such as a mobile phone or smartphone, in addition to a personal computer (PC), such as a laptop computer.

The AP 200 provides a wireless communication service to the communication terminal equipment 300. Communication technology in a wireless section of the AP 200 and the communication terminal equipment 300 is a well-known technology and thus, a more detailed description thereof will be omitted. However, the AP 200 may be a device that provides a local wireless LAN service to the communication terminal equipment 300 or a wireless base station that provides a mobile communication service as part of a mobile communication network. That is, embodiments of the present invention are not necessarily limited to a wireless LAN environment.

The APC 100 performs authentication on the communication terminal equipment 300 that accesses each AP 200.

For example, the APC 100 may determine whether a user is an already-registered user using an Internet protocol (IP) address, a media address control (MAC) address, a log-in identifier (ID), and a password, which are received from the communication terminal equipment 300.

That is, a schematic procedure of performing authentication on the communication terminal equipment 300 using the APC 100 will be described below.

If the communication terminal equipment 300 requests provision of a wireless service for connection to a predetermined communication network, for example, an Internet network, from the AP 200, the AP 200 transmits a service start request signal to the APC 100, and the APC 100 performs user authentication using a MAC address or a log-in ID/password of the communication terminal equipment 300, as described above.

In case of the authenticated communication terminal equipment 300 as a result of performing authentication, the APC 100 transmits a service start allowable signal to the AP 200, and the AP 200 provides a wireless service to the communication terminal equipment 300. That is, the AP 200 allows the communication terminal equipment 300 to be connected to the communication network.

In case of the unauthenticated communication terminal equipment 300 as a result of performing authentication, the APC 100 transmits a service start denying signal to the AP 200, and the AP 200 denies provision of a wireless service to the communication terminal equipment 300. That is, the AP 200 denies connection of the communication terminal equipment 300 to the communication network.

It is a well-known technology that the APC 200 allows or denies the wireless service to the particular communication terminal equipment 300 depending on an authentication procedure of the APC 100 and a result of performing authentication of the APC 100, and thus a more detailed description thereof will be omitted.

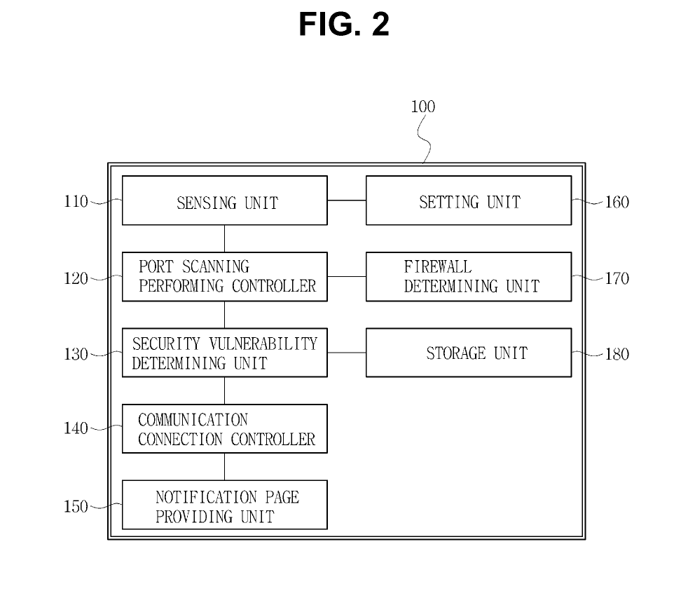

Hereinafter, features of the APC 100 according to the present invention will be described with reference to a functional block of FIG. 2.

As illustrated in the same drawing, the APC 100 may include a sensing unit 110, a port scanning performing controller 120, a security vulnerability determining unit 130, a communication connection controller 140, a notification page providing unit 150, a setting unit 160, a firewall determining unit 170, and a storage unit 180.

Various pieces of information for performing the function of the APC 100 are stored in the storage unit 180. For example, the APC 100 periodically exchanges a management message with the AP 200, and information included in the management message may be stored in the storage unit 180. Content set in each AP 200 and an IP address allocated to each AP 200 may be included in the management message. Also, information (network address) regarding each communication terminal equipment 300 may be stored in the storage unit 180, and furthermore, information for authentication of the communication terminal equipment 300, for example, a user ID, a password, and a terminal equipment address, may also be stored in the storage unit 180.

The setting unit 160 performs a function of setting a service set identifier (SSID) for analyzing vulnerability in each of the APs 200. For example, a plurality of SSIDs may be set in each AP 200. The setting unit 160 may set a particular SSID for checking whether there is a security vulnerability checking request from the communication terminal equipment 300, that is, an SSID for analyzing vulnerability, in each AP 200, as will be described later. A procedure of using the SSID for analyzing vulnerability will be described later.

As another example, the setting unit 160 may also set at least one of an IP address and a port number for analyzing vulnerability, for example, a pair of an IP address and a port number, in each AP 200. Here, the IP address and the port number for analyzing vulnerability are used to check whether there is a security vulnerability checking request from the communication terminal equipment 300, as will be described later. A procedure of using the IP address and the port number for analyzing vulnerability using the communication terminal equipment 300 will be described later.

The firewall determining unit 170 performs a function of determining whether a firewall is present between the APs 200 and the APC 100 if the sensing unit 110 senses occurrence of a security vulnerability checking event on the particular terminal equipment.

For example, if an IP address of a message packet received from the communication terminal equipment 300 is compared with an IP address included in a message and the IP address of the message packet is different from the IP address included in the message, it may be determined that a firewall is present. That is, it may be determined that a private IP is allocated to the communication terminal equipment 300. Technology for determining presence of the firewall and the private IP is a well-known technology and thus, a more detailed description thereof will be omitted.

The notification page providing unit 150 performs a function of providing a predetermined notification page to the communication terminal equipment 300. For example, when the notification page provided by the communication terminal equipment 300 is a web page, the notification page providing unit 150 performs a kind of web server function.

The sensing unit 110 performs a function of sensing whether a predetermined security vulnerability checking event on the particular communication terminal equipment 300 occurs.

Here, a security vulnerability checking event signal may be generated as a particular request of an operator of the APC 100 is inputted. For example, when the operator of the APC 100 selects the particular communication terminal equipment 300 using a network management system (NMS), the sensing unit 110 determines that the security vulnerability checking event on the particular communication terminal equipment 300 selected by the operator of the APC 100 has occurred.

As another example, the security vulnerability checking event may occur as the particular request of a user of the particular communication terminal equipment 300 is received. For example, when the user of the particular communication terminal equipment 300 by himself/herself requests security vulnerability checking by manipulating the particular communication terminal equipment 300 or accesses a particular SSID (for example, an SSID for analyzing vulnerability) of the APs 200 or accesses the APs 200 with a particular IP or port number (for example, an IP and a port number for analyzing vulnerability), the sensing unit 110 may determine that the security vulnerability checking event on the particular communication terminal equipment 300 has occurred.

If it is determined by the sensing unit 110 that the security vulnerability checking event on the particular communication terminal 300 has occurred, the port scanning performing controller 120 performs a function of controlling port scanning on the particular terminal equipment 300.

For example, if, as a result of determination of the firewall determining unit 170, no firewall is present, the port scanning performing controller 120 may directly perform port scanning on the communication terminal equipment 300, and if, as the result of determination of the firewall determining unit 170, a firewall is present, the port scanning performing controller 120 may control the APs 200 to perform port scanning on the communication terminal equipment 300. In the latter case, it is obvious that the APs 200 may perform port scanning on the communication terminal equipment 300 and may inform the APC 100 of a result of performing.

That is, if a private IP is allocated to the communication terminal equipment 300, the port scanning performing controller 120 controls the APs 200 to perform port scanning, and if a public IP is allocated to the communication terminal equipment 300, the port scanning performing controller 120 may directly perform port scanning.

Here, port scanning is a procedure in which a port that is opened to the communication terminal equipment 300 is checked. For example, it may be determined whether the port is opened according to whether a request signal is transmitted to the communication terminal equipment 300 via an already-known, particular port and a response signal is received from the communication terminal equipment 300 via the already-known, particular port.

The port scanning procedure itself is a well-known technology and thus, a more detailed description thereof will be omitted.

If, as a result of performing port scanning on the particular communication terminal equipment 300, a predetermined particular port is opened, the security vulnerability determining unit 130 performs a function of determining that security vulnerability has occurred in the particular communication terminal equipment 300. Here, information regarding the particular port to be determined may be set and stored in the storage unit 180 described above.

For example, when an 80th port (web server port) is set in the storage unit 180, the security vulnerability determining unit 130 may determine that security vulnerability has occurred in the communication terminal equipment 300 when the 80th port is opened to the communication terminal equipment 300.

As another example, the security vulnerability determining unit 130 may determine that security vulnerability has occurred in the communication terminal equipment 300 if the predetermined port is closed or the number of opened ports exceeds a predetermined number, as a result of performing port scanning on the particular communication terminal equipment 300.

The communication connection controller 140 performs a function of determining whether each communication terminal equipment 300 is to be connected to the outside, for example, an Internet network, and controlling the APs 200 so as to perform processing based on the result of determination.

For example, the communication connection controller 140 may control so that the communication terminal equipment 300 that is authenticated as a result of performing authentication can be connected to an external communication network and the communication terminal equipment 300 that is not authenticated as the result of performing authentication cannot be connected to the external communication network and can be denied.

In particular, the communication connection controller 140 performs a function of controlling so that communication connection of the communication terminal equipment 300 to a communication network can be denied, if the communication terminal equipment 300 determined that security vulnerability has occurred, as a result of determination of the security vulnerability determining unit 130, attempts communication connection to the communication network via the APs 200.

In this case, when a communication connection request signal of the communication terminal equipment 300 is transmitted to the communication network via the APC 100 in addition to the APs 200, the APC 100 may deny communication connection of the communication terminal equipment 300, and when the communication connection request signal of the communication terminal equipment 300 is transmitted to the communication network via only the APs 200, the APC 100 may control the APs 200 so that communication connection of the communication terminal equipment 300 can be denied.

In this way, when communication connection of the communication terminal equipment 300 to the communication network is denied by the communication connection controller 140, the above-described notification page providing unit 150 may control so that a security vulnerability warning page can be transmitted to the denied communication terminal equipment 300.

For example, the notification page providing unit 150 may generate the security vulnerability warning page and may transmit the generated security vulnerability warning page to the communication terminal equipment 300 via the APs 200.

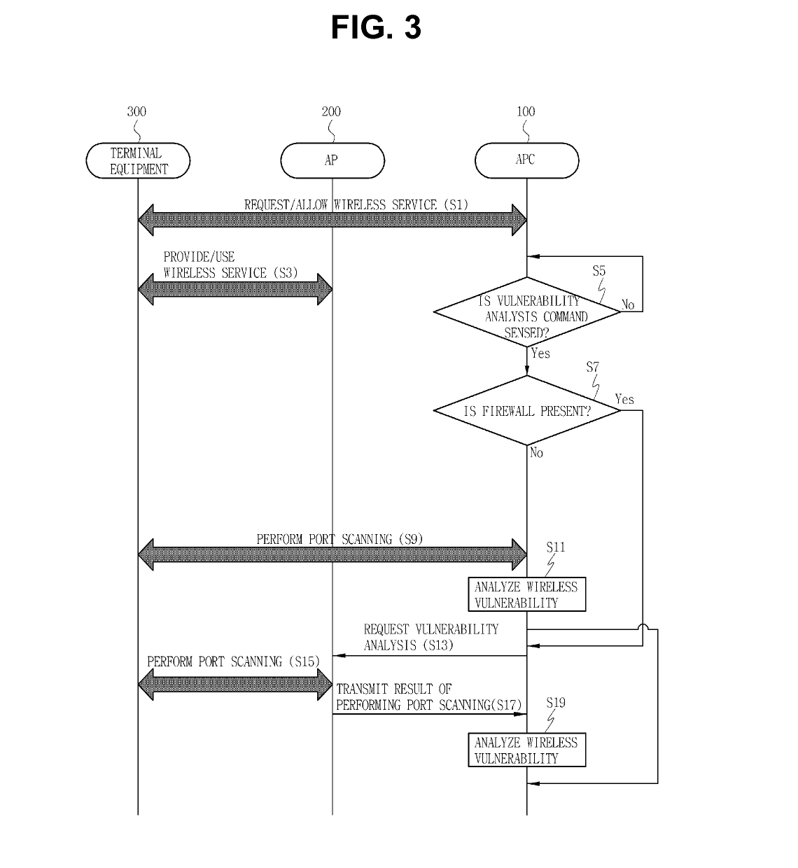

Hereinafter, a control flow and signal flow of the whole communication system including the APC 100 according to an embodiment of the present invention will be described with reference to FIGS. 3 through 6.

First, the following description will be provided below with reference to FIG. 3.

First, it is assumed that the communication terminal equipment 300 requests a wireless service from the APC 100 via the APs 200 and the wireless service is allowed from the APC 100 (Operation S1). That is, the APC 100 may perform authentication on the communication terminal equipment 300 and may transmit a result of authentication to the APs 200 so that the communication terminal equipment 300 can access other communication networks, such as Internet. This is a well-known technology and thus, a more detailed description thereof will be omitted.

Thus, the communication terminal equipment 300 may receive the wireless service, i.e., a wireless communication connection service, from the APs 200 and may be connected to a communication network (Operation S3).

On the other hand, if the APC 100 senses a vulnerability analysis command regarding the communication terminal equipment 300 that receives the wireless service from an operator (Operation S5), the APC 100 determines whether a firewall is present between the APs 200 and the APC 100 (Operation S7).

If the firewall is present between the APs 200 and the APC 100, the APC 100 transmits a vulnerability analysis request signal to the AP 200 (Operation S13). Thus, the AP 200 performs port scanning on the communication terminal equipment 300 (Operation S15) and transmits a result of performing port scanning to the APC 100 (Operation S17).

The APC 100 analyzes whether wireless vulnerability is present in the particular communication terminal equipment 300 using the result of performing port scanning received from the AP 200 (Operation S19).

On the other hand, if no firewall is present between the APs 200 and the APC 100, the APC 100 may directly perform port scanning on the communication terminal equipment 300 (Operation S9) and may analyze wireless vulnerability of the communication terminal equipment 300 using the result of performing port scanning (Operation S11).

The above-described procedure has been described as a procedure in which wireless vulnerability analysis is performed on the particular communication terminal equipment 300 according to a command of the operator of the APC 100. However, wireless vulnerability analysis may also be performed according to a request of the communication terminal equipment 300, i.e., a request of a user of the communication terminal equipment 300.

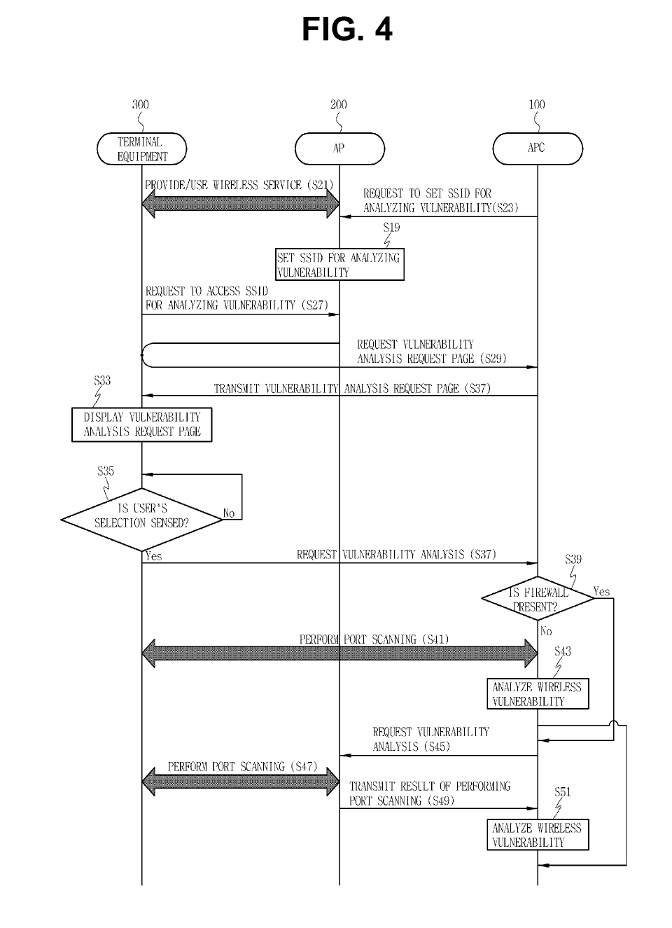

Hereinafter, a procedure in which wireless vulnerability analysis is performed according to the request of the communication terminal equipment 300, i.e., a request of the user of the communication terminal equipment 300, will be described with reference to FIG. 4.

It is assumed that the communication terminal equipment 300 receives a wireless service from the APs 200 after undergoing authentication (Operation S21).

Here, the APC 100 may transmit an SSID setting request signal for analyzing vulnerability to the AP 200 (Operation S23), and the AP 200 may set the SSID for analyzing vulnerability according to a request of the APC 100 (Operation S25). Here, the SSID for analyzing vulnerability is set to perform vulnerability analysis of the communication terminal 300 and thus, a more detailed description thereof will be provided later.

The user who wants to check wireless vulnerability on the communication terminal equipment 300 transmits an access request signal to the predetermined SSID for analyzing vulnerability among at least one SSID provided by the APs 200 by manipulating the communication terminal equipment 300 (Operation S27).

For example, the user of the communication terminal equipment 300 may select an SSID for analyzing vulnerability among SSID lists of the APs 200 recognized by the communication terminal equipment 300 and may request an access. In this case, the APs 200 may cause the communication terminal equipment 300 to be connected to the APC 100 so as to request a vulnerability analysis request page using forwarding of signals.

As another example, the APs 200 may use a meta tag of a hypertext markup language (HTML) used in a hypertext transfer protocol (HTTP). For example, the APs 200 may cause a web page including a meta tag ‘<Meta http-equiv=“Refresh” url=“Server.com/secure.asp”>’ to be transmitted to terminal equipment (Operation S29). Here, Server.com is an address of the APC 100, and secure.asp is a path on which the vulnerability analysis request page is requested. The communication terminal equipment 300 requests the vulnerability analysis request page from the APC 100 according to the web page including the meta tag (Operation S29), and the APC 100 transmits the vulnerability analysis request page to the communication terminal equipment 300 (Operation S31).

The communication terminal equipment 300 displays the vulnerability analysis request page received from the APC 100 (Operation S33), and if selection of the user who has read the page is sensed (Operation S35), the communication terminal equipment 300 requests vulnerability analysis from the APC 100 (Operation S37).

The APC 100 determines whether a firewall is present, as mentioned above in FIG. 3 (Operation S39), and if the firewall is present, the APC 100 transmits the vulnerability analysis request signal to the APs 200 (Operation S45), and the APs 200 perform port scanning on the communication terminal equipment 300 (Operation S47) an then transmit a result of performing port scanning to the APC 100 (Operation S49), and the APC 100 analyzes wireless vulnerability using the result of performing port scanning received from the APs 200 (Operation S51).

On the other hand, if no firewall is present, the APC 100 directly performs port scanning on the communication terminal equipment 300 (Operation S41) and analyzes wireless vulnerability on the communication terminal equipment 300 using the result of performing port scanning (Operation S43).

The APC 100 may perform wireless vulnerability analysis on the communication terminal equipment 300 according to the above-described procedure.

In FIG. 4, an example in which an SSID for analyzing vulnerability is set in each AP 200, has been described. However, a particular IP address and a particular port number may be set in each AP 200. In this case, the APC 100 may provide a vulnerability analysis request page to the communication terminal equipment 300 that accesses the APs 200 with the set IP address and port number.

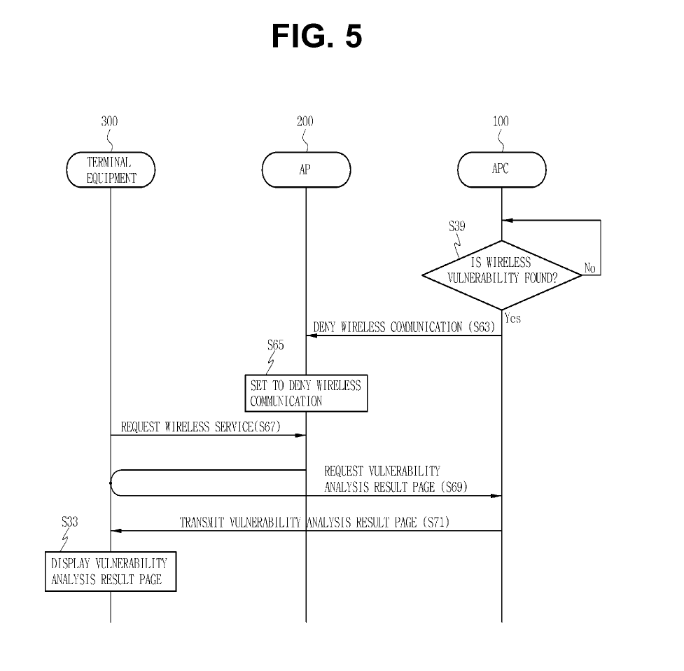

FIG. 5 illustrates a procedure in which wireless vulnerability is found from the communication terminal equipment 300.

If wireless vulnerability is found from the communication terminal equipment 300 through the procedure of FIG. 3 or 4 (Operation S61), the APC 100 transmits a wireless communication denying signal to the AP 200 (Operation S63).

The APs 200 set wireless communication denying on the communication terminal equipment 300 according to a request of the APC 100 (Operation S65), and if there is a wireless service request from the communication terminal equipment 300 or an access to a particular Internet site is sensed, the APs 200 deny the wireless service request or the access but rather control the communication terminal equipment 300 to be connected to the APC 100 (Operation S69).

For example, the APs 200 control the communication terminal equipment 300 to request a vulnerability analysis result page from the APC 100 using the meta tag of the HTML described above.

The APC 100 transmits the vulnerability analysis result page to the communication terminal equipment 300 according to the request of the communication terminal 300 (Operation S71), and the communication terminal equipment 300 displays the vulnerability analysis result page received from the APC 100 (Operation S73).

Thus, the user of the communication terminal equipment 300 who wants to access a particular web site can read the vulnerability analysis result page having content in which the communication terminal equipment 300 cannot be connected to the particular web site due to security vulnerability.

The vulnerability analysis result page may also be transmitted to the communication terminal equipment 300 at a time when wireless vulnerability has been found.

In the above-described embodiment, the APs 200 and the APC 100 are physically separated from each other. However, the APs 200 may be configured to include characteristic functions of the APC 100 described above.

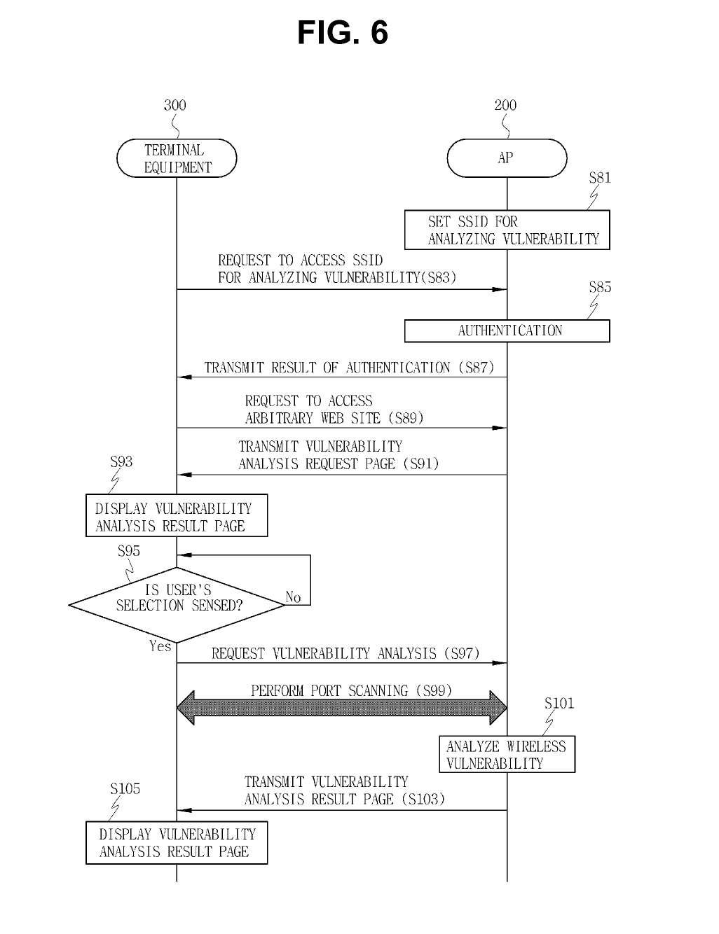

FIG. 6 illustrates an example of a procedure of the APs 200 having the features of the APC 100.

First, the APs 200 set an SSID for analyzing vulnerability (Operation S81). Of course, the APs 200 may set a pair of a particular IP address and a port number instead of the SSID, as mentioned in the above embodiments.

When the communication terminal equipment 300 requests an access to the SSID for analyzing vulnerability (Operation S83), the APs 200 perform authentication on the communication terminal equipment 300 (Operation S85) and transmit a result of performing authentication to the communication terminal equipment 300 (Operation S87). In the current embodiment, it is assumed that the communication terminal equipment 300 is authenticated terminal equipment.

When the communication terminal equipment 300 requests an access to an arbitrary web site according to the user's manipulation (Operation S89), the APs 200 sense that the communication terminal equipment 300 is communication terminal equipment 300 that accesses the SSID for analyzing vulnerability and transmit a vulnerability analysis request page to the communication terminal equipment 300 (Operation S91).

The communication terminal equipment 300 displays the vulnerability analysis request page received from the APs 200 (Operation S93). In this case, if the user selects vulnerability analysis (Operation S95), the communication terminal equipment 300 requests vulnerability analysis from the APs 200 (Operation S97).

Thus, the APs 200 perform port scanning on the communication terminal equipment 300 (Operation S99) and analyze wireless vulnerability on the communication terminal equipment 300 using a result of performing port scanning (Operation S101). For example, the APs 200 may determine that wireless vulnerability is present, if a predetermined port is opened to the communication terminal equipment 300.

Subsequently, the APs 200 transmit the vulnerability analysis result page to the communication terminal equipment 300 (Operation S103), and the communication terminal equipment 300 displays the received vulnerability analysis result page so that the user can read the vulnerability analysis result page (Operation S105).

Meanwhile, it is obvious that the above-described procedures for implementing each of the embodiments may be performed using a program stored in a predetermined recording medium, for example, a computer-readable recording medium.

As described above, according to the embodiments of the present invention, security vulnerability of communication terminal equipment can be easily found according to selection of a user of the communication terminal equipment or selection of an operator of an APC.

In particular, the user of the communication terminal equipment accesses a particular SSID of an AP so that security vulnerability checking can be performed on the communication terminal equipment and thus the user's conveniences can be increased.

While this invention has been particularly shown and described with reference to exemplary embodiments thereof, it will be understood by those skilled in the art that various changes in form and details may be made therein without departing from the spirit and scope of the invention as defined by the appended claims.

1. A control method of an access point controller (APC) so that predetermined terminal equipment is capable of being connected to a predetermined communication network via a plurality of access points (APs), the control method comprising:
(a) if occurrence of a predetermined security vulnerability checking event on particular terminal equipment is sensed, controlling port scanning on the particular terminal equipment; and
(b) determining that security vulnerability has occurred in the particular terminal equipment in at least one of a case where the predetermined port is opened, a case where the predetermined port is closed, and a case where the number of opened ports exceeds a predetermined number, as a result of performing port scanning on the particular terminal equipment.

2. The control method of claim 1, further comprising, if the particular terminal equipment determined that security vulnerability has occurred in (b), attempts communication connection to a communication network via the APs, controlling the APs so that communication connection of the particular terminal equipment to the communication network is denied and controlling the APs so that a security vulnerability warning page is transmitted to the particular terminal equipment.

3. The control method of claim 1, wherein (a) comprises controlling the APs so that port scanning is capable of being performed on the particular terminal equipment as an operator's request is sensed.

4. The control method of claim 1, wherein (a) comprises controlling the APs so that port scanning is capable of being performed on the particular terminal equipment as a request of a user of the particular terminal equipment is sensed.

5. The control method of claim 4, wherein (a) comprises:
(a1) setting a service set identifier (SSID) for analyzing vulnerability in each of the APs; and
(a2) if a request for communication connection of the particular terminal equipment that accesses the SSID for analyzing vulnerability is received, controlling the APs so that port scanning is capable of being performed on the particular terminal equipment.

6. The control method of claim 4, wherein (a) comprises:
(a1) setting an Internet protocol (IP) address and a port number for analyzing vulnerability in each of the APs; and
(a2) if a request for communication connection of the particular terminal equipment that accesses the IP address and the port number for analyzing vulnerability is received, controlling the APs so that port scanning is capable of being performed on the particular terminal equipment.

7. The control method of claim 5, wherein (a2) comprises:
if a request for communication connection is received from the particular terminal equipment, controlling the APs so that a vulnerability analysis request page is capable of being transmitted to the particular terminal equipment; and
if a vulnerability analysis request signal is received from the particular terminal equipment using the vulnerability analysis request page, controlling the APs so that port scanning is capable of being performed on the particular terminal equipment.

8. The control method of claim 1, wherein (a) comprises:
(a1) if occurrence of a predetermined security vulnerability checking event on the particular terminal equipment is sensed, determining whether a firewall is present between the APs and the APC; and
(a2) if, as a result of determining in (a1), no firewall is present, performing port scanning on the particular terminal equipment, and if, as the result of determining in (a1), a firewall is present, controlling the APs so that port scanning is capable of being performed on the particular terminal equipment.

9. An access point controller (APC) so that predetermined terminal equipment is capable of being connected to a predetermined communication network via a plurality of access points (APs), the APC comprising:
a sensing unit sensing whether a predetermined security vulnerability checking event on particular terminal equipment occurs;
a port scanning performing controller controlling port scanning on the particular terminal equipment if occurrence of the predetermined security vulnerability checking event on the particular terminal equipment is sensed by the sensing unit; and
a security vulnerability determining unit determining that security vulnerability has occurred in the particular terminal equipment in at least one of a case where the predetermined port is opened, a case where the predetermined port is closed, and a case where the number of opened ports exceeds a predetermined number, as a result of performing port scanning on the particular terminal equipment.

10. The APC of claim 9, further comprising:
a communication connection controller controlling the APs so that communication connection of the particular terminal equipment to the communication network is denied, if, as a result of determining of the security vulnerability determining unit, the particular terminal equipment determined that security vulnerability has occurred in (b), attempts communication connection to a communication network via the APs; and
a notification page providing unit controlling the APs so that a security vulnerability warning page is transmitted to the particular terminal equipment if communication connection of the particular terminal equipment to a communication network is denied by the communication connection controller.

11. The APC of claim 9, wherein the security vulnerability checking event occurs as an operator's particular request is inputted.

12. The APC of claim 9, wherein the security vulnerability checking event occurs as a particular request of a user of the particular terminal equipment is received.

13. The APC of claim 12, further comprising a setting unit setting a service set identifier (SSID) for analyzing vulnerability in each of the APs,
wherein the sensing unit determines that the security vulnerability checking event has occurred if a request for communication connection of the particular terminal equipment that accesses the SSID for analyzing vulnerability is received.

14. The APC of claim 12, further comprising a setting unit setting an Internet protocol (IP) address and a port number for analyzing vulnerability in each of the APs,
wherein the sensing unit determines that the security vulnerability checking event has occurred if a request for communication connection of the particular terminal equipment that accesses the IP address and the port number for analyzing vulnerability is received.

15. The APC of claim 13, further comprising a notification page providing unit,
wherein, if the sensing unit senses occurrence of the security vulnerability checking event, the port scanning performing controller controls the notification page providing unit so that a vulnerability analysis request page is capable of being transmitted to the particular terminal equipment, and if a vulnerability analysis request signal is received from the particular terminal equipment via the vulnerability analysis request page, the port scanning performing controller controls the APs so that port scanning is capable of being performed on the particular terminal equipment.

16. The APC of claim 9, further comprising a firewall determining unit determining whether a firewall is present between the APs and the APC if the sensing unit senses occurrence of a security vulnerability checking event on the particular terminal equipment,
wherein the port scanning performing controller directly performs port scanning on the particular terminal equipment if, as a result of determining of the firewall determining unit, no firewall is present, and the port scanning performing controller controls the APs so that port scanning is capable of being performed on the particular terminal equipment, if, as the result of determining of the firewall determining unit, a firewall is present.

17. The control method of claim 6, wherein (a2) comprises:
if a request for communication connection is received from the particular terminal equipment, controlling the APs so that a vulnerability analysis request page is capable of being transmitted to the particular terminal equipment; and
if a vulnerability analysis request signal is received from the particular terminal equipment using the vulnerability analysis request page, controlling the APs so that port scanning is capable of being performed on the particular terminal equipment.

18. The APC of claim 14, further comprising a notification page providing unit,
wherein, if the sensing unit senses occurrence of the security vulnerability checking event, the port scanning performing controller controls the notification page providing unit so that a vulnerability analysis request page is capable of being transmitted to the particular terminal equipment, and if a vulnerability analysis request signal is received from the particular terminal equipment via the vulnerability analysis request page, the port scanning performing controller controls the APs so that port scanning is capable of being performed on the particular terminal equipment.
